(19) United States
(12) Patent Application Publication
(10) Pub. No.: US 2024/0396143 A1
(43) Pub. Date: Nov. 28, 2024

(54) BATTERY TRAY

(71) Applicant: BENTELER AUTOMOBILTECHNIK GMBH, Paderborn (DE)

(72) Inventors: Christian HANDING, Langenberg (DE); Kai MICHEL, Salzkotten (DE); Stefan SCHMITZ, Bielefeld (DE)

(21) Appl. No.: 18/670,770

(22) Filed: May 22, 2024

(30) Foreign Application Priority Data
May 24, 2023 (EP) 23175118.1

(51) Int. Cl. H01M 50/242; B60L 50/64; H01M 50/249

(52) U.S. Cl. CPC H01M 50/242; B60L 50/64; H01M 50/249; H01M 2220/20

(57) ABSTRACT

A battery tray for holding battery elements for providing electrical energy in electrically powered vehicles. The battery tray has a battery pan with a reinforcing structure which is arranged on the outside in front of a side wall of the battery pan. The reinforcing structure includes an inner profile and an outer profile, wherein the inner profile 5 has a U-shaped cross-section with a web and two legs as well as an opening, wherein the legs of the inner profile face away from the battery pan and the opening of the inner profile is closed at least in length by the outer profile.

### RELATED APPLICATIONS

The present application claims priority of European Application Number 23175118.1 filed May 24, 2023, the disclosure of which is hereby incorporated by reference herein in its entirety.

### FIELD

The present disclosure relates to a battery tray.

### BACKGROUND

To hold battery elements for providing electrical energy in electrically powered vehicles, battery trays are used, which are arranged between the axles of the vehicle. One of the safety requirements for a battery tray is good crash performance. In order to satisfy these requirements, the battery pan is protected by an external reinforcing structure.

DE 10 2018 126 068 A1 makes a battery tray for an electric vehicle part of the state of the art. The battery tray has a battery pan which is inserted into an outer frame and is closed by a lid. The frame is made in cross section from at least two profile components joined together, wherein at least one of these profile components is manufactured as a sheet metal forming component.

In DE 10 2016 120 826 B4, the battery pan is protected by a frame structure that surrounds on the battery pan on the outside and has a hollow chamber.

DE 10 2018 120 371 B4 describes a battery tray with an external reinforcement through a frame structure which having several hollow chamber profile parts connected to one another in the area of their ends.

Furthermore, WO 2018/166895 A1 describes a battery tray for accommodating battery elements with a frame forming an interior region, which at least partially provides side walls of the battery tray, and a reinforcing structure that has one or more reinforcing profiles.

The battery trays are mechanically stable and attached to the body or chassis of a vehicle. The battery tray should be integrated as far as possible into the body, which presents design and assembly challenges.

### SUMMARY

The object of the present disclosure is to create a battery tray with improved functionality and crash performance.

A battery tray for holding battery elements for providing electrical energy in electrically driven vehicles has a battery pan with a reinforcing structure which is arranged on the outside in front of at least one side wall of the battery pan.

The reinforcing structure includes an inner profile and an outer profile. The inner profile is configured with a U-shaped cross-section and has a web and two legs as well as an opening. The web is oriented parallel to the side wall. The legs of the inner profile point away from the battery pan so that the open side of the inner profile is on the outside. The open side or the opening of the inner profile is closed at least in length by the outer profile.

This configuration leads to a battery tray that is improved functionally and in terms of crash performance, and in terms of stiffness behavior. The inner profile is easily accessible via the opening and the open side of the inner profile that faces away from the battery pan. This improves the functionality, such as the accessibility and the assembly of the inner profile itself as well as of the components to be installed in the inner profile. The inner profile and the outer profile complement each other synergistically. The reinforcing structure extends in the longitudinal direction of the side wall. The inner profile and the outer profile form a box-shaped hollow profile at least over the majority of the length of the reinforcing structure. This is characterized by advantageous static and dynamic load behavior. The rigidity of the reinforcing structure transverse to the battery pan is improved. In the event of a side impact, the legs of the inner profile are able to deform with energy dissipation, wherein the outer profile acts as a tension strut and still holds the legs in position relative to one another. Closed in length sections means that the opening of the inner profile is able to be closed by an outer profile over the entire length of the inner profile. The outer profile is able to only close the opening on a length section of the inner profile. Several outer profiles are able to be provided, which close the opening of the inner profile at least over the majority of the length. An outer profile is able to be perforated, so as to save weight, or is able to be provided with holes and recesses. The outer profile is able to have oval or rectangular holes or recesses. Rectangular holes or recesses have rounded corner areas. Such oval or rectangular holes or recesses designed as elongated holes have a dimension between 20×80 mm and 60×80 mm. Holes or recesses in the outer profile are able to be used to join the reinforcing structure to the side wall of the battery pan.

At least one sleeve is provided in the reinforcing structure. These are fastening or assembly sleeves. A plurality of sleeves arranged at a distance from one another are provided in the longitudinal direction of the reinforcing structure. A sleeve extends between the legs of the inner profile over the entire height of the inner profile. The sleeve connects openings in the legs. The sleeves are oriented coaxially with the openings. The sleeve and opening lie on a common longitudinal axis. The sleeves are used to carry out fasteners through which the battery tray is secured in the body or chassis of a vehicle. The battery tray is secured to side sills and/or floor cross members in the motor vehicle using the sleeves and suitable fastening means.

The present disclosure provides that the sleeves have an upper and/or a lower collar. A collar is oriented outward from the sleeve body. The collar is able to be a component of the sleeve made of the same material or formed by a separate collar body. The collars absorb the friction and pressure forces that arise when tightening assembly elements guided through the sleeves, for example screw fasteners. This is able to protect the surface of the components in the area of a screw connection from damage and reduce the surface pressure. The collars ensure tolerance compensation. The flat collar surface is larger than the sleeve surface, so that the sleeves or their sleeve bodies are able to be aligned or positioned horizontally before welding with the inner profile. The alignment takes place according to the defined lateral sill hole distances. A sleeve or the sleeve body of a sleeve is able to be in several parts. A sleeve is able to include two parts, i.e., two sleeve body parts. The two sleeve body parts are joined together during assembly in the reinforcing structure.

The sleeves are able to rest with their collars on the inside of a leg of the inner profile. In the present disclosure, the sleeves rest on the outside of the legs. A two-part sleeve has two sleeve body parts. A sleeve body part is passed from the outside through an opening in one leg, so that the collars rest on the outside of the inner legs. The sleeves are then joined to the inner profile in the area of the collar. Furthermore, the two sleeve body parts are brought together inside the inner profile and joined together. This is able to be done non-positively and/or positively. The connection between the two sleeve body parts are able to be done by teeth or by a press fit. A bayonet-like connection is also possible.

A two-part sleeve is advantageous in terms of assembly. Each sleeve body part is guided through an upper or lower leg opening and connected in a partially overlapping manner, by means of a press fit. Positioned in the inner profile, the sleeves are welded to the inner profile or the legs of the inner profile via the collars.

A sleeve is able to be formed by an inner sleeve and an outer sleeve.

Joining tabs are provided at the ends of the legs of the inner profile. A plurality of spaced-apart joining tabs are provided in the longitudinal direction of the inner profile along longitudinal edge sections of the legs. The joining tabs protrude outwards. An alternating row of joining tabs is provided on each leg along its longitudinal edge section. The joining tabs are spaced apart from one another in the longitudinal direction of one leg, so that there are free spaces between the joining tabs.

The outer profile is supported on the free ends or the longitudinal edge sections of the legs and/or on the joining tabs of the legs.

A joining tab is positioned at an angle to one leg. The joining tabs are directed outwards away from the free end of the legs. This improves accessibility, such as for the production of spot welded connections. The installation space on the outside is also reduced.

The outer profile has joining webs which are supported on the legs of the inner profile.

The outer profile with joining webs lies against the joining tabs in some areas.

The outer profile is cohesively connected to the inner profile. This is done via a cohesive connection between the joining tabs of the inner profile and the joining webs of the outer profile. The cohesive connection between the joining tabs and the joining web takes place by means of a spot weld connection or spot weld bonding. These joining techniques ensure a low heat input into the components during cohesive joining. In principle, roll seam welding or laser welding are also possible.

In the present disclosure, upper and lower joining tabs are provided. An upper tab is located at the end on the upper leg of the inner profile. A lower joining tab is located at the free end of the lower leg of the inner profile. The upper joining tab and the lower joining tab are each oriented outwards at an angle from the associated upper leg and lower leg, respectively. Here, the upper joining tab and the lower joining tab are directed away from each other.

The upper joining tabs and the lower joining tabs are arranged at a tab opening angle to one another. The tab opening angle is able to be between greater than or equal to (≥) 45° and less than or equal to (≤) 240°. The tab opening angle is in a range between 80° and 150°. The tab opening angle measures between 60° and 120°.

The joining tabs on the inner profile and the joining webs on the outer profile are contour-adapted to one another and complement each other. The joining tabs and the joining webs are set at the same angle and aligned complementary to one another.

In the present disclosure, built-in elements are provided in the reinforcing structure. Installation elements could be load guides, bulkhead plates and similar internal reinforcing and/or functional components.

The reinforcing structure is connected to the battery pan. For this purpose, the inner profile is joined to the battery pan. The inner profile with its rear web is joined against a side wall of the battery pan. The open inner profile is accessible from the side. The sleeves as well as other installation elements are able to be inserted and mounted in the open inner profile. The inner profile is then closed by one or more outer profiles. Each outer profile is connected to the upper leg and the lower leg and acts as a tensile load strut between the legs, which counteracts the inner profile from spreading in the event of a side impact.

Cutouts or recesses are provided between the joining tabs on the legs of the inner profile. The contour of the legs are able to be tailored to the connection to joining surfaces. In this context, one embodiment provides that the inner profile is embossed or retracted in areas in the area of an installation element and/or in the area of a sleeve.

In addition to built-in elements in the reinforcing structure, reinforcing or stiffening elements are able to be integrated in the battery pan. Such reinforcing or stiffening elements are able to be formed by longitudinal and/or transverse profiles or struts that extend on the tray floor.

A lid is able to form the upper end of the battery pan. The battery tray is able to be integrated into the body or chassis of a vehicle. The battery tray forms a supporting part of the body (cell-to-body). The floor of the vehicle can form the battery cover.

The battery pan is a deep-drawn part made in one piece and made of the same material. The inner profile and the outer profile are able to be produced using compression molding or deep-drawing technology. Due to its U-shaped cross section, the inner profile has a channel-like course in which several sleeves are arranged at a distance from one another in the longitudinal direction. The at least one outer profile shifts the inner profile like a striking plate over at least part of its length. Several external profiles are able to be provided in the longitudinal direction of the reinforcing structure. The one or more external profiles form the outer wall of the reinforcing structure.

The battery pan is able to be formed from a sheet metal plate by folding it into a battery pan. For this purpose, a sheet metal plate is provided whose geometry corresponds to the development of the battery pan. A cooling plate is able to optionally be joined directly to the sheet metal circuit board before it is then folded to form the battery pan. The battery pan is designed as a folding component. Folding corners of the battery pan are joined and sealed.

The battery pan as well as the reinforcing structure and the components forming the reinforcing structure, such as the inner shell, but also the outer shell, are able to be formed by hardening steel sheets. Mold hardening is also referred to as press hardening. During mold hardening, a sheet of manganese-boron steel is heated to a temperature above the specific austenitization temperature of the material, placed in a forming tool and warmly formed into a molded component, and cools during forming. Clamped in the forming tool, the molded components are hardened by cooling.

Coated, shape-hardenable steel sheets are able to be used here, for example manganese-boron steel sheets provided with an aluminum/silicon coating. The components of the reinforcing structure and the battery pan have tensile strengths of 1,000 MPa and higher.

The battery pan as well as the inner profile and/or the outer profile of the reinforcing structure are able to be made from extra-and ultra-high-strength cold-form steels. The components have a tensile strength of more than 980 MPa, such as the inner profile has a tensile strength of ≥1,180 MPa.

In principle, in both cases tailored blanks of different sheet thicknesses are able to be used, steel grades or technologies to create tailored strength properties with local soft zones for the battery pan as well as for the inner profile and/or the outer profile, for example to prevent cracks during welding or for the targeted adjustment of locally weakened zones with better deformation capacity for energy absorption.

### BRIEF DESCRIPTION OF THE DRAWINGS

The present disclosure is described in more detail hereinafter with reference to exemplary embodiments illustrated in the drawings. Showing:

FIG. 1 a battery tray according to the present disclosure in a cross-sectional view;

FIG. 2 the battery tray in a schematic top view according to the present disclosure,

FIG. 3 a cross section through the reinforcing structure of the battery tray as shown in FIG. 2 along line A-A according to the present disclosure;

FIG. 4 a cross section through the reinforcing structure of the battery tray as shown in FIG. 2 along line B-B according to the present disclosure;

FIG. 5 a cross section through the reinforcing structure of the battery tray as shown in FIG. 2 along line C-C according to the present disclosure;

FIG. 6 a cross section through the reinforcing structure of the battery tray as shown in FIG. 2 along line D-D according to the present disclosure;

FIG. 7 a section of the reinforcing structure of the battery tray in the area of a mounting sleeve in a perspective according to the present disclosure;

FIG. 8 a side view of the representation corresponding to FIG. 7 according to the present disclosure;

FIG. 9 the representation corresponding to FIG. 7 in a perspective view obliquely from the front according to the present disclosure;

FIG. 10 a further embodiment of a battery tray according to the present disclosure in a cross-sectional view;

FIG. 11 the battery tray as shown in FIG. 10 in a schematic top view according to the present disclosure;

FIGS. 12 to 15 each a technically schematic cross section through further embodiments of a reinforcing structure according to the present disclosure;

FIG. 16 a section of a reinforcing profile with the representation of the joining area between the inner profile and the outer profile according to the present disclosure;

FIG. 17 to FIG. 19 each a technically schematic cross section through further embodiments of a reinforcing structure according to the present disclosure;

FIG. 20 a view on another embodiment of an reinforcing structure according to the present disclosure; and

FIG. 21 the representation according to FIG. 20 in a cross-section.

### DETAILED DESCRIPTION

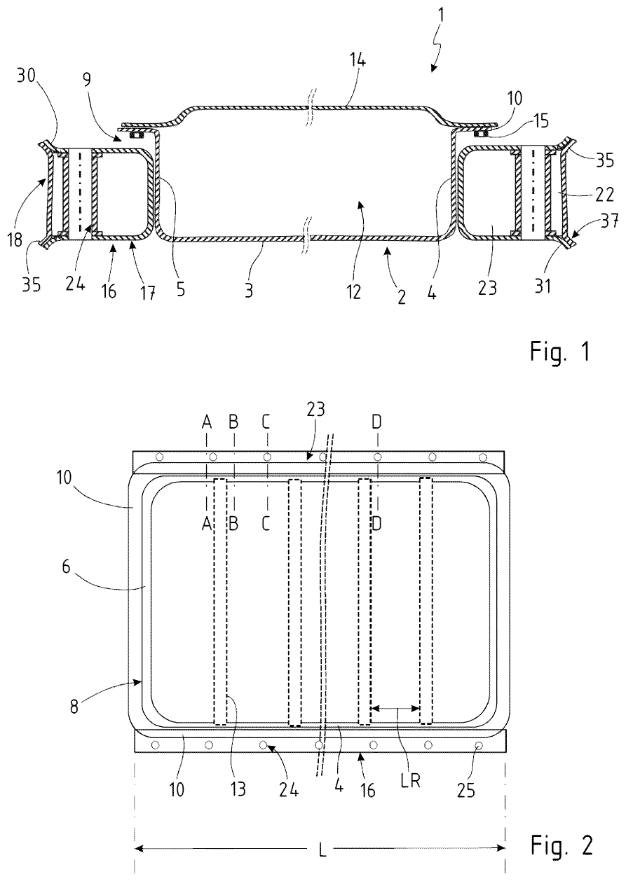

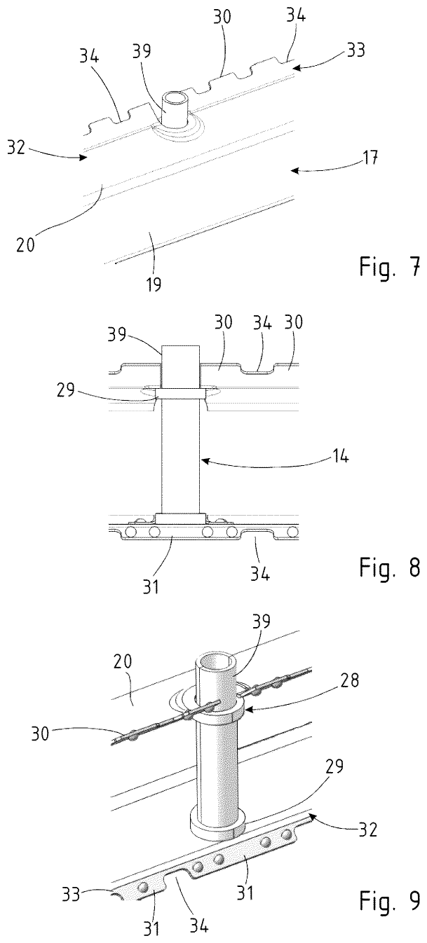

In FIG. 1 to FIG. 21, the same reference numerals are used for identical or functionally corresponding components or component parts, even if a repeated description is omitted for reasons of simplicity.

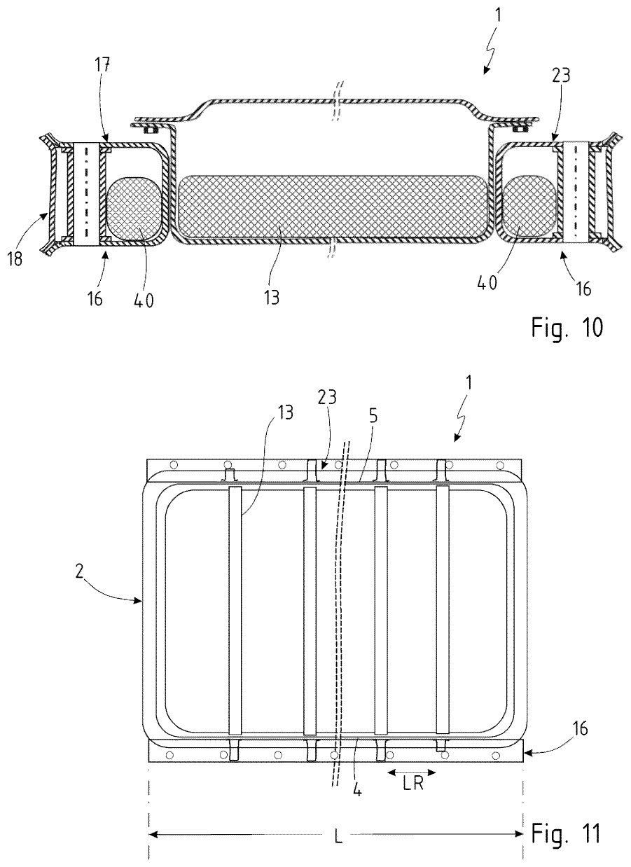

FIG. 1 and FIG. 2 as well as FIG. 10 and FIG. 11 show a battery tray 1 according to the present disclosure and components thereof.

The battery tray 1 has a battery pan 2 deep-drawn from sheet steel. The battery pan 2 has a rectangular cross-section and has a tray base 3 and side walls, for example two longitudinal walls 4, 5 and two end walls 6, 7, which complement each other to form a circumferential tray wall 8. On the upper edge of the tray 9, outwardly directed flange sections 10 extend along the longitudinal walls 4, 5 and the end walls 6, 7, which are also closed all the way around to form an upper flange 11. The tray wall 8 delimits a tray interior 12 of the battery pan 2.

A plurality of inner struts 13 are arranged in the tray interior 12, optionally and as shown schematically in FIG. 2 and in FIG. 10 and FIG. 11. The inner struts 13 extend on the tray base 3 transversely between the longitudinal walls 4, 5 and are firmly secured in the battery pan 2.

The battery pan 2 is closed on the top side by a lid 14, which rests on the flange 11 at the edge. In the exemplary embodiments shown, the lid 14 is detachably connected to the battery pan 2 by means of screw connection means 15.

The battery tray 1 has a reinforcing structure 16. The reinforcing structure 16 extends on the outside of the battery pan 2 in front of the longitudinal walls 4, 5.

As shown in FIG. 1 and FIG. 3 to FIG. 6 and FIG. 10, a reinforcing structure 16 has an inner profile 17 and an outer profile 18. The inner profile 17 is configured with a U-shaped in cross section and has a rear web 19 as well as two legs 20, 21 and an outside opening 22. The legs 20, 21 of the inner profile 17 are directed away from the battery pan 2. The web 19 extends parallel to the side wall or a longitudinal wall 4, 5. The opening 22 of the inner profile 17 is closed at least in sections by the outer profile 18.

Both the inner profile 17 and the outer profile 18 are sheet metal parts that are formed from steel sheets. These are able to form-hardened sheet steel components or cold-formed molded components made of, for example, ultra-high-strength (UHSS) cold-form steels.

The reinforcing structure 16 extends in the longitudinal direction LR of a longitudinal wall 4, 5. The inner profile 17 and the outer profile 18 form a hollow profile 23 at least over the majority of the length L of the reinforcing structure 16.

Several sleeves 24 are provided in the hollow profile 23 of the reinforcing structure 16. These extend vertically between the legs 20, 21 of the inner profile 17. Openings 25, 26 are provided in the upper leg 20 and the lower leg 21, which are connected by the sleeves 24 (see also FIG. 7 to FIG. 9). The sleeves 24 have a sleeve body 27. A collar 28, which is formed by a disk body 29, is provided on the top and bottom of the sleeves 24. The openings 25, 26 in the upper leg 20 and in the lower leg 21, the sleeves 24 and the disk bodies 29 each lie on a common sleeve longitudinal axis LH and are arranged concentrically to this.

At the ends of the legs 20, 21, joining tabs 30, 31 are provided. The joining tabs 30, 31 extend outwards from the ends 32 on longitudinal edge sections 33 of a leg 20, 21. The joining tabs 30, 31 are set at an angle α to the associated leg 20, 21, to which they adjoin. In FIG. 7 and FIG. 9 the outer longitudinal edge sections 33 at the ends 32 of the legs 20, 21 are angled relative to the legs 20, 21. The joining tabs 30, 31 run along the longitudinal edge sections 33 and protrude from them.

Upper joining tabs 30 are provided on the upper leg 20. Lower joining tabs 31 are provided on the lower leg 21. A plurality of joining tabs 30, 31 are arranged alternately in the longitudinal direction LR of the legs 20, 21 along the length of the inner profile 17 (see FIG. 7 to FIG. 9). There are free spaces 34 between the individual joining tabs 30, 31. The upper joining tabs 30 on the upper leg 20 and the lower joining tabs 31 on the lower leg 21 are directed away from each other.

The outer profile 18 has joining webs 35, 36. These each extend along the outer longitudinal edges 37 of the outer profile 18. With the joining webs 35, 36, the outer profile 18 rests in the area of a joining tab 30, 31. In the area of the free spaces 34, the outer profile 18 with the outer joining webs 35, 36 each rests on a leg 20, 21 of an inner profile 17 on its longitudinal edges 33. The joining tabs 30, 31 and the joining webs 35, 36 are congruent with one another.

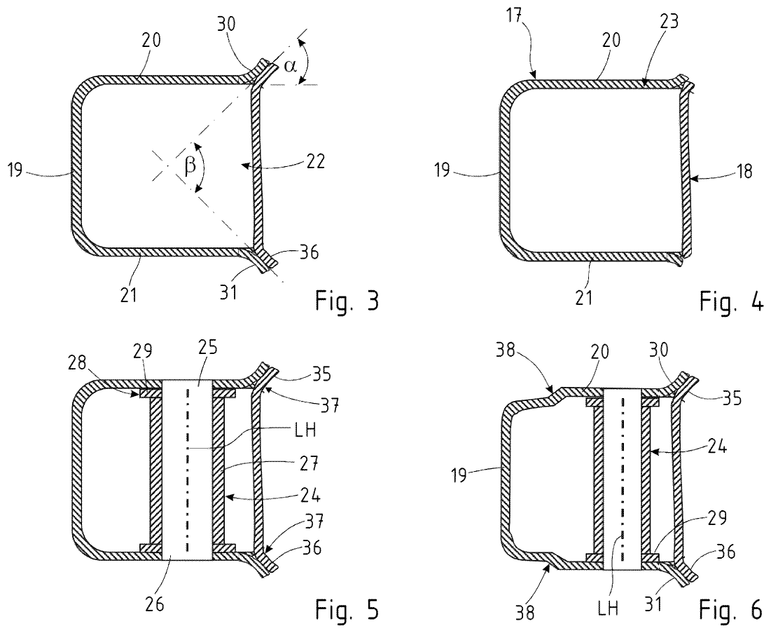

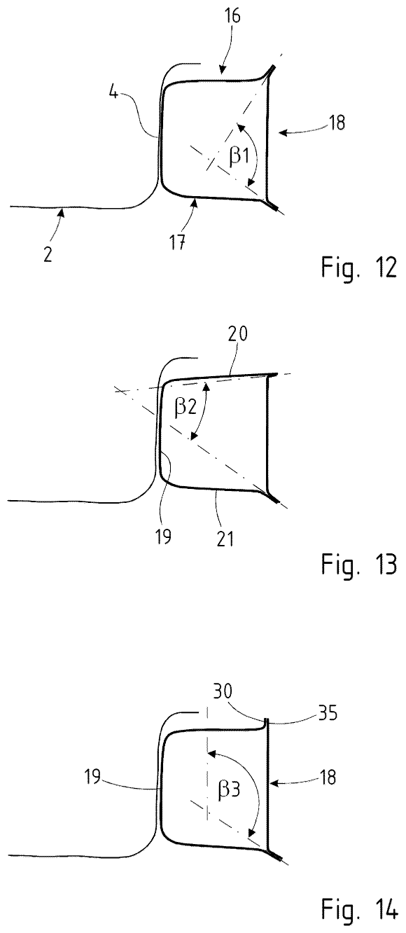

The upper joining tabs 30 and the lower joining tabs 31 are arranged at a tab opening angle β relative to one another (see in FIG. 3 and FIG. 12 to FIG. 15). The tab opening angle β is able to be between greater than or equal to (≥) 45° and less than or equal to (≤) 200°. The representation of FIG. 12 to FIG. 15 show different embodiment variants of a reinforcing structure 16 and the tab opening angles β resulting from the alignment of the joining tabs 30, 31 and the joining webs 35, 36 relative to one another. In the representation of FIG. 12, the tab opening angle β1 is approximately 95°.

The representation of FIG. 13 shows a reinforcing structure 16 with a tab opening angle β2 between the joining tabs 30, 31 and the joining webs 35, 36 of 40°+/−2°.

The tab opening angle β3 when the internal profile 17 and the external profile 18 are embossed in the reinforcing structure 16, as shown in FIG. 14, is approximately 125°.

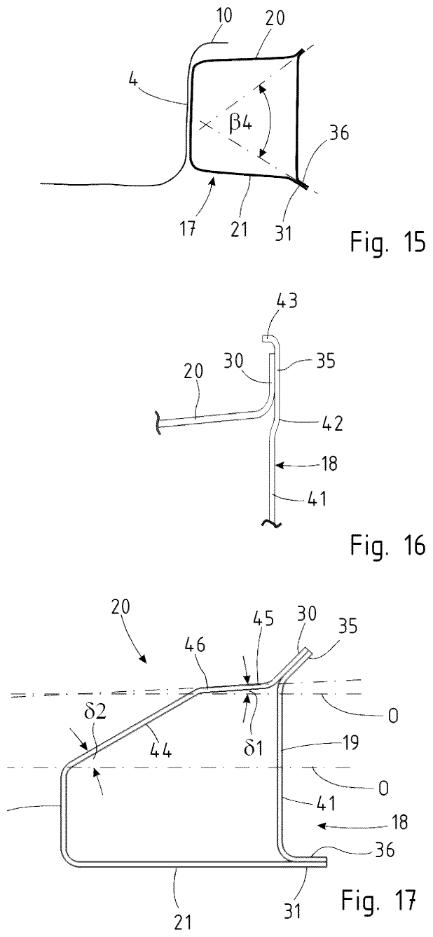

The tab opening angle β4 of the reinforcing structure 16, as shown in FIG. 15, is approximately 67°.

In FIG. 3 to FIG. 5, cross-sections are represented by the reinforcing structure 16 of the battery tray 1 along the lines A-A, B-B, C-C and D-D.

The tab opening angle β, as shown in FIG. 3, is 90°. FIG. 4 shows a cross section through the reinforcing structure 16 in an area in which the joining tabs 30, 31 merge into a free space 34.

FIG. 5 and FIG. 6 illustrate that sleeves 24 are used, which have different diameters. Based on FIG. 6 the course of the legs 20, 21 transversely to the longitudinal direction of the inner profile 17 is able to have a contour that deviates from a straight course. A rear part is cranked by a changeover 38.

In FIG. 9, the sleeves 24 are able to protrude with sleeve sections 39 on the outside relative to the reinforcing structure 16 and above the upper leg 20.

In FIG. 10, an installation element 40 is schematised and simplified, which is installed in the inner profile 17 or the hollow profile 23 of the reinforcing structure 16. Such built-in elements 39 are able to be, for example, load guide bodies or bulkhead plates. These are joined to the inner profile 17 in a cohesive manner.

The installation of sleeves 24 as well as the assembly and fixing of installation elements 40 is carried out from the outside with an open inner profile 17, before the outer profile 18 closes the sleeves 24 at least in length. For this purpose, the outer profile 18 is cohesively joined to the inner profile 17 by spot welding. This takes place between the joining tabs 30, 31 and the joining webs 35, 36.

FIG. 16 shows a section of a reinforcing profile 16. At the end of the leg 20, a joining tab 30 is bent outward away from the leg. The outer profile 18 is coupled to the joining tab 30. The outer profile 18 has an outer joining web 35. This is slightly offset outwards relative to a central section 41 of the outer profile 18 via a changeover 42. On the outer edge, the outer profile 18 or the joining web 35 has an edge strip 43 that is moved in the direction of the leg 20. The joining web 35 rests on the joining tab 30 and is joined thereto by spot welding or spot weld gluing.

In the cross section through a reinforcing structure 16 shown in FIG. 17, the upper leg 20 has two leg sections 44, 45. The leg sections 44, 45 are aligned inclined relative to one another.

The leg sections 44, 45 are connected via a bend 46. The leg sections 44, 45 are inclined to an orthogonal O formed by the web 19. The front leg section 45 in the direction of the outer profile 18 occupies an angle δ1 with the orthogonal O. The rear leg section 44 makes an angle δ2 with the orthogonal O. On the opening side, the leg section 45 is adjoined by an outwardly converted joining tab 30, to which a joining web 35 of the outer profile 18 rests and is joined.

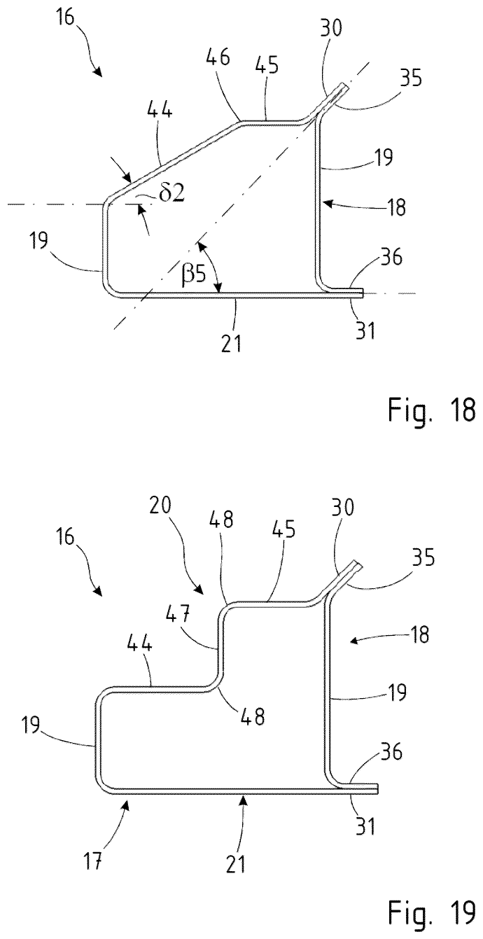

The cross section of a reinforcing structure 16 shown in FIG. 18 corresponds to that of FIG. 17. However, the front leg section 45 runs parallel to the lower leg 21. The leg section 45 is therefore aligned in a straight line conforming to the lower leg 21. The rear leg section 44 runs inclined between the web 19 and the front leg section 45. In the exemplary embodiment shown, the angle of inclination δ2 is approximately 30 degrees.

Both in the embodiment of the reinforcing structure 16 according to the representation in FIG. 17 and in FIG. 18, the lower joining tab 31 is aligned in a straight line as an extension of the lower leg 21. The associated joining web 36 of the outer profile 18, which is in contact with the joining tab 31 and is joined, is bent at right angles to the web 19 of the outer profile 18 and runs parallel to the lower joining tab 31. The tab opening angle β5 between the upper joining tab 30 and the lower one Flange 31 is 45 degrees.

In the cross section through a reinforcing structure 16 shown in FIG. 19, the upper leg 20 has three leg sections 44, 45 and 47. The two leg sections 44, 45 are oriented parallel to the lower leg 21. The leg section 47 runs perpendicular to the lower leg 21. The leg sections 44, 45, 47 each merge into one another via a curve or fold 48. By aligning the leg sections 44, 45, 47 relative to one another, a step is formed in the leg 20.

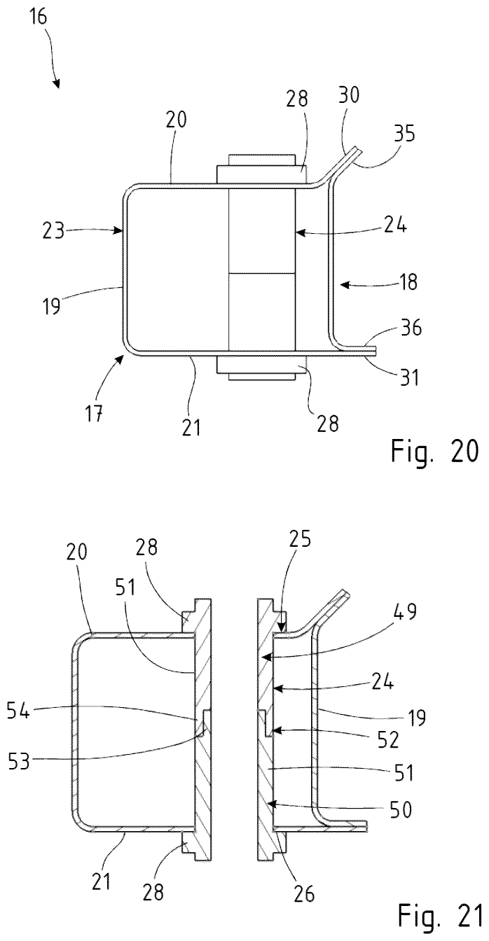

The embodiment of the reinforcing structure 16, as shown in FIG. 20 and FIG. 21, correspond in basic structure to that described previously.

The reinforcing structure 16 has an inner profile 17 and an outer profile 18. The inner profile 17 is configured in a U-shaped cross section. U-shaped means that the inner profile 17 has a rear web 19 and two legs 20, 21 and an opening 22, wherein the legs 20, 21 and the opening 22 of the inner profile 17 face away from a battery pan. The open side or the opening 22 of the inner profile is closed at least in length by the outer profile 18. At the ends of the legs 20, 21, joining tabs 30, 31 are provided, against which joining webs 35, 36 of the outer profile rest and are cohesively joined to the joining tabs 30, 31, such as spot welded or spot weld bonded.

A sleeve 24 is arranged in the hollow profile 23 of the reinforcing structure 16. In the longitudinal direction of the hollow profile 23 or the reinforcing structure 16, several such sleeves 24 extend at a distance from one another.

The sleeve 24 extends vertically between the legs 20, 21 of the inner profile 17. In the upper leg 20 there is an upper opening 25 and in the lower leg 21 there is a lower opening 26, which are connected by the sleeve 24.

The sleeve 24 is in two parts and has a first sleeve body part 49 and a second sleeve body part 50. Each sleeve body part 49, 50 has a sleeve section 51, with which the sleeve body part 49 or 50 is guided through the opening 25 or 26. At the end, the sleeve body parts 49, 50 have circumferential collars 28, which rest on the outside of the upper leg 20 and lower leg 21, respectively. The sleeve 24 or the sleeve body parts 49, 50 are joined to the legs 20, 21 via the collars 28.

The sleeve body parts 49, 50 are coupled to one another via a positive connection 52. This is designed like a tooth. For this purpose, the sleeve section 51 of the second sleeve body part 50 has an inner radial extension 53, which is surrounded by an outer radial collar 54 of the sleeve section 51 on the first sleeve body part 49.

1-14: (canceled)

15. A battery tray, comprising:
a battery pan; and
a reinforcing structure arranged on an outside in front of a side wall of the battery pan, wherein
the reinforcing structure comprises an inner profile, at least one sleeve, and an outer profile,
the inner profile comprises a U-shaped cross section with a web, two legs and an opening, the legs and the opening of the inner profile face away from the battery pan, and the opening of the inner profile is closed at least in length sections by the outer profile, and
the at least one sleeve extends between the two legs, and the at least one sleeve connects openings in the two legs.

16. The battery tray according to claim 15, wherein the reinforcing structure extends in a longitudinal direction of the side wall, and the inner profile and the outer profile configure a hollow profile at least over a length of the reinforcing structure.

17. The battery tray according to claim 15, wherein the at least one sleeve comprises at least one of an upper collar or a lower collar.

18. The battery tray according to claim 15, wherein the at least one sleeve comprises two sleeve body parts coupled to each other.

19. The battery tray according to claim 15, wherein the two legs comprise joining tabs at respective ends of the two legs, and the outer profile is coupled to the joining tabs.

20. The battery tray according to claim 19, wherein at least one of the joining tabs extends at an angle relative to a respective leg of the two legs.

21. The battery tray according to claim 19, wherein the joining tabs comprise an upper joining tab on an upper leg of the two legs and a lower joining tab on a lower leg of the two legs, and the upper and lower joining tabs are directed away from each other.

22. The battery tray according to claim 21, wherein the upper joining tab and the lower joining tab are arranged relative to one another at a tab opening angle, and the tab opening angle is greater than or equal to 45 degrees and less than or equal to 240 degrees.

23. The battery tray according to claim 15, wherein the outer profile comprises joining webs supported on the two legs of the inner profile.

24. The battery tray according to claim 15, wherein at least one leg of the two legs comprises at least one leg section inclined to a normal direction of the web.

25. The battery tray according to claim 15, wherein at least one leg of the two legs comprises multiple leg sections, and at least two leg sections of the multiple leg sections are oriented differently relative to one another.

26. The battery tray according to claim 25, wherein the at least two leg sections are connected via a bend, a curvature, a step, a kink or a shoulder.

27. The battery tray according to claim 15, further comprising built-in elements in the reinforcing structure.

28. The battery tray according to claim 15, wherein joining tabs are at respective ends of the two legs, the outer profile comprises joining webs, the outer profile is supported by the joining webs resting on the joining tabs, and the joining webs are spot-welded or spot-weld-bonded weld-bonded to the joining tabs.

29. The battery tray according to claim 21, wherein the upper joining tab and the lower joining tab are arranged relative to one another at a tab opening angle, and the tab opening angle is greater than or equal to 80 degrees and less than or equal to 150 degrees.

30. The battery tray according to claim 21, wherein the upper joining tab and the lower joining tab are arranged relative to one another at a tab opening angle, and the tab opening angle is greater than or equal to 60 degrees and less than or equal to (≤) 120 degrees.
